(19) United States
(12) Patent Application Publication
(10) Pub. No.: US 2014/0317080 A1
(43) Pub. Date: Oct. 23, 2014

(54) MULTI-DIMENSIONAL RELEVANCY SEARCHING

(71) Applicant: THE CLEVELAND CLINIC FOUNDATION, Cleveland, OH (US)

(72) Inventors: David Piraino, Shaker Hts., OH (US); Joshua M. Polster, Shaker Hts., OH (US); Erika Schneider, Rocky River, OH (US)

(73) Assignee: THE CLEVELAND CLINIC FOUNDATION, Cleveland, OH (US)

(21) Appl. No.: 14/258,660

(22) Filed: Apr. 22, 2014

Related U.S. Application Data
(60) Provisional application No. 61/814,671, filed on Apr. 22, 2013.

(51) Int. Cl. G06F 17/30

(52) U.S. Cl. CPC G06F 17/30864
USPC 707/706

(57) ABSTRACT

A method includes preprocessing extracted text to generate a pre-search document that specifies context field data relevant to a patient encounter. The extracted text can be derived from at least one of clinical encounter data and provider input data related to the patient encounter. The method includes constructing a multidimensional query based on the pre-search document. This includes sending the multidimensional query to a search engine to retrieve relevant data related to the patient encounter. The method includes generating an output for the patient encounter based on the retrieved relevant data.

### CROSS-REFERENCE TO RELATED APPLICATION

This application claims the benefit of U.S. Provisional Patent Application 61/814,671 filed on Apr. 22, 2013, and entitled MULTI-DIMENSIONAL RELEVANCY SEARCHING, the entirety of which is incorporated by reference herein.

### TECHNICAL FIELD

This disclosure relates to information retrieval systems, such as to provide multi-dimensional relevancy searching in a healthcare context.

### BACKGROUND

An Electronic Medical Record (EMR) is a digital version of a paper chart that contains all of a patient's medical history from one practice. It is mostly used by providers for diagnosis and treatment. An EMR is more beneficial than paper records because it allows providers to: track data over time, identify patients who are due for preventive visits and screenings, monitor how patients measure up to certain parameters, such as vaccinations and blood pressure readings, and improve overall quality of care in a practice. The information stored in EMRs is not easily shared with providers outside of a practice. A patient's record might even have to be printed out and delivered by mail to specialists and other members of the care team. The real power is in the data base structure of the electronic medical record. The power is maximized when clinical decision support tools are developed to mine the data in the records. Pattern recognition software tools will find critical relationships buried in the mountains of patient data. These software products produce automated in a variety of formats including Standard Query Language (SQL) reports, for example.

EMRs normally store their data in an underlying relational database (e.g., Oracle, SQL-Server, Access, MySQL) or hierarchical/object database (MUMPS, M, Cache) in “transactional” form. The transactional form includes all information needed to conduct the healthcare enterprise, including “internal” data of little interest to the end consumer/clinician (internal date-time stamps, update codes, workstation origin codes, incremental data updates, and so forth). In some circumstances, there is a case to be made for extracting key clinical data (extraction), cleaning up the data (transformation), and writing (loading) the data into a database specifically designed to ease data analysis. This sequence of events is the warehousing process. Since every EMR has at its heart a database, the method of entering and retrieving data is a special programming language for databases—SQL (Structured Query Language). SQL is considered a 4th generation programming language as it works at a “higher” level than 3rd generation languages such as C, Java, etc. Specifically, the database system is told what information needs to be extracted, not how to do it (this is determined by the database system's query optimizer).

Database reporting tools provide an “attractive” front end for the querying process, often shielding the analyst from the raw SQL code. Such tools include Crystal Reports, Microsoft's Access Query tool (which can be used for both Access and non-Access queries), as well as the database vendor's own internal querying tools. The key to a successful query and report is a properly framed question and the appropriate ODBC driver (“translator”) between the database system and the query tool. However, these EMRs are not currently optimized to retrieve or integrate or present the textual information to users in the most understandable ways. Current EMRs show information to the user in a time-oriented patient-specific manner. They are also encumbered by a lack of coordination.

### SUMMARY

This disclosure relates to information retrieval systems, such as to provide multi-dimensional relevancy searching in a healthcare context.

As one example, a method includes preprocessing extracted text to generate a pre-search document that specifies context field data relevant to a patient encounter. The extracted text can be derived from at least one of clinical encounter data and provider input data related to the patient encounter. The method includes constructing a multidimensional query based on the pre-search document. This includes sending the multidimensional query to a search engine to retrieve relevant data related to the patient encounter. The method includes generating an output for the patient encounter based on the retrieved relevant data.

In another example, a non-transitory computer readable media having instructions executable by a processor. The instructions comprising include a preprocessor to process extracted text to generate a pre-search document that specifies context field data relevant to a patient encounter. The extracted text can be derived from at least one of clinical encounter data and provider input data related to the patient encounter. A query constructor generates a multidimensional query from the extracted text and a query sender submits the multidimensional query to a search engine to retrieve relevant data related to the patient encounter. An interface provides an output for the relevant data for the patient encounter based on the retrieved relevant data.

In yet another example, a method includes preprocessing extracted text to generate a pre-search document that specifies context field data relevant to a patient encounter. The extracted text can be derived from at least one of clinical encounter data and provider input data related to the patient encounter. The method includes constructing a multidimensional query from the extracted text and sending the multidimensional query to a search engine to retrieve relevant data related to the patient encounter. This includes revising the multidimensional query during the patient encounter based upon an update to the clinical encounter data or the provider input data. The method includes sending the revised multidimensional query to the search engine to retrieve updated relevant data related to the patient encounter.

### BRIEF DESCRIPTION OF THE DRAWINGS

FIG. 1 illustrates an example of a system for performing multi-dimensional retrieval of data based on relevancy at the point of care.

FIG. 2 illustrates a system for preprocessing existing medical records in to discrete fields that can be later searched for medical relevance.

FIG. 3 is a search flow diagram illustrating search retrieval of relevant medical documents and data.

FIGS. 4 and 5 illustrate example user interfaces to display relevant medical data that has been retrieved according to the systems and methods described herein.

FIG. 6 illustrates an example method for preprocessing medical records into a non-SQL database.

FIG. 7 illustrates a method for preprocessing point of care input to generate a query to retrieve relevant medical data from a non-SQL database.

### DETAILED DESCRIPTION

This disclosure relates to information retrieval systems, such as to provide multi-dimensional relevancy searching. In some examples, systems and methods are provided for classifying and searching medical records based on relevancy, such that retrieval of such information can be facilitated. Such retrieval can occur, for example, at the point of care rendered by a health care provider (e.g., a physician, nurse, assistant or the like). Various medical information is document oriented (e.g., text) with varying amounts of associated meta-data (e.g., numerical codes and/or values). Moreover, much of this information is textual unstructured or semi-structured and is specific to particular patient visit thus precludes critical knowledge outside of the visit (e.g., labs, other clinical notes, other diagnosis, related imaging, and so forth).

Typical medical information systems are constructed using relational databases that are optimized for transactional data but are not optimal for dealing with either text or semi-structured information. Thus, most Electronic Medical Record (EMR) systems are currently constructed using relational databases and have been optimized to perform the transactional parts of medicine including work-flow, inputting information, and storing information. These EMRs are not currently optimized to retrieve or integrate or present the textual information to users in the context-specific, understandable ways. Current EMRs show information to the user in a time-oriented patient-specific manner. This is a very linear (one-dimensional) and restrictive method to present information at the point of care. Also, EMRs are able to display a lot of patient specific data but are not able to integrate it with other related information or to display the most relevant information.

The systems and methods described herein display the content of textual documents and integrate with other types of information based upon user, patient, and work-flow specific relevancy criteria. Thus, the display of relevant information is generated as a multiple level and faceted search problem. Search technologies other than structured language queries have the ability to search both textual information and structured information at the same time thus facilitating higher dimensional searches. This provides the ability to perform complex searches over large amounts of textual and non-textual information. The integrated patient-level data that is context specific can provide faster and more effective communication of information between the EMR and the user.

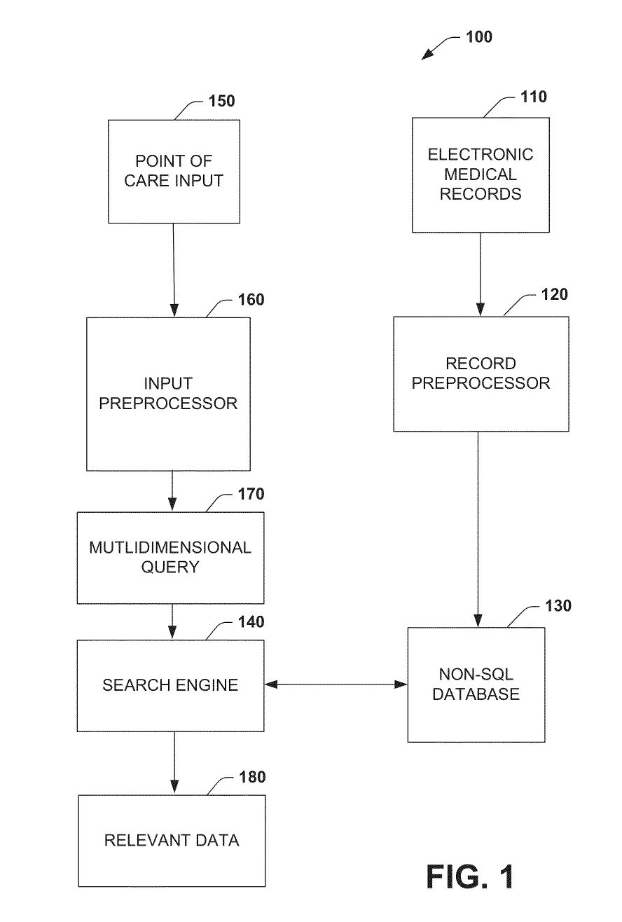

FIG. 1 illustrates an example of a system 100 for performing multi-dimensional retrieval of data based on relevancy, such as can be implemented at the point of care. An EMR system 110 includes documents, metadata, and field level (discrete) medical data. For example, EMR data can be preprocessed via a record preprocessor 120 using a pipeline to optimize the data content and to extract additional field level information. The output of the preprocessor 120 can be input into a non-SQL database 130 and be indexed by a document and field level search engine 140 (e.g., natural language processor (NLP)). After the information is indexed, it can be searched and integrated. Information can be ordered by relevance using multiple different dimensions or facets.

The search criteria can be determined by point of care patient-specific information as well as work-flow and user based information. As shown, point-of care input 150 is entered by a physician or other medical personnel. Such data is preprocessed by an input preprocessor 160 that configures, filters, and aligns the data as it is entered at 150 in such a manner as to be compatible with the format stored in the database 130. The input preprocessor 160 utilizes preformed queries that are combined with the point of care input 150 to define multidimensional queries 170 that are submitted to the search engine 140. The search engine 140 searches the non-SQL database 130 for all data that is ranked most relevant to the user (e.g., statistical scoring criteria associated with stored data). As the information is retrieved from the database 130, it is presented to the user as relevant data 180.

Some of the deficiencies of prior searching methods dealt with the fact the prior systems such as SQL and ODBC could only search discrete fields. In addition to discrete fields, the system 100 can search text in context with discrete fields to determine medical relevancy. For instance, prior searching methods could only focus on about 10-15% of data contained in an electronic medical record whereas the system 100 can integrate the other 80-85 percent of textual information in the medical record to determine medical relevancy which was not possible with previous search methods. Thus, the system 100 provides point of care identification of relevancy (using both discrete data and results from text processing), identification and integration of relevant patient-centric information at the point of care, and comparison of these data to other similar patient presentations among other features. Hence, the system 100 can integrate both current and retrospective data as well as anticipate what might next be happening. This can include both current and retrospective cases if either evidence-based medicine or a care path exists as well as by comparison with the clinical sequel and outcomes of other patients with similar presentations and/or histories.

In one example, the record preprocessor 120 and non-SQL database can be based upon an open source natural language platform (e.g., LUCENE APACHE Platform). The input preprocessor 160 and search engine 140 can also be based on and/or employ an open source platform (e.g., SOLR APACHE Search Platform). Data stored in the database 130 can be any medical data, including but not limited to data derived from an electronic medical record. Moreover, the information can be a compilation from any number of one or more sources of data, such as can be distributed across one or more health care enterprises or other data sources. This can include lab data, image data (e.g., MRI, CT, Ultrasound, and so forth), other physician diagnostic data, clinical notes, data from medical journals/libraries, and related data from other patients, for example. The search engine 140 can employ an inverted index to query the database 130 and generate a relevant list or display of results for the relevant data 180 based on the query. A graphical user interface (not shown) can be provided to show the relevant data 180 and will be illustrated and described below.

The EMR 110 can be preprocessed into discrete, searchable fields based on natural language, for example. Fields can include dates, times, parts of the anatomy, diagnosis of the anatomy, and positive, negative, or uncertain statements. An example of a positive statement is “Meniscus tear detected.” An example of a negative statement is “No sign of Meniscus tear.” An example of an uncertain statement would be “Possible tear further analysis required.” After the records 110 have been discretized into fields in the database 130, natural language queries can be conducted against the database 130 at the point of care to retrieve relevant data 180. For example, in contrast to prior systems which could only retrieve data related to the particular patient at given points of time by the attending physician, the system 100 can retrieve other relevant data related to other physicians diagnosis of the given patient or other similarly situated patients, for example. This can include automatically retrieving related lab work, clinical notes, medical images, data relating to the current diagnosis, or data related to other patients who may be afflicted with a similar medical issue. Thus, as used herein, multi-dimensions refers to the ability to not only retrieve information related to the given patient and past contacts with a given physician but to also acquire related or relevant information outside that single domain and can be useful for diagnosing and treating the given patient.

Data can be entered at the point of care input 150 via various means. This can include dictation equipment that can turn spoken words into text. This can also include keyboard text and/or biometric input directly received from the patient (e.g., blood pressure, heart rate, temperature, and so forth). As the data is being entered, the input preprocessor 160 continually refines the multi-dimensional query 170 in order to retrieve the most relevant data 180. For instance, the input preprocessor 160 can determine whether a positive or negative statement has been made via the point of care input 150 and utilize such statement to further refine the query 170 to enhance retrieval relevance from the ongoing search. For example, the attending physician might dictate “Lower extremity, right knee” which would form the basis of an initial natural language query 170. In addition, the physician might state “No arthritis detected” which is a positive statement. Such positive statement can be utilized to enhance the query 170 to not retrieve information where arthritis is detected, for example. In another case, if arthritis were detected, not only would information relating to arthritis in the knee be retrieved, but the patient may have seen another physician for pain in the hand which may be related to the arthritic knee condition. Moreover, outside the given patient conditions, other similarly situated patients' data can be retrieved to provide further diagnostic information. This can include retrieving the latest medical research on the given condition and the various treatment alternatives available.

As the point of care input 150 is entered, other preprocessing can occur by the input preprocessor 160. For example semantic preprocessing can filter that although the lower extremity is involved, that ankle data (part of lower extremity) is not to be retrieved since the focus is on the knee. Furthermore, the left knee may have been replaced from a previous accident thus only the current condition of the right knee as described by the attending physician is deemed relevant. After semantic preprocessing, and positive, negative, or neutral statement preprocessing has occurred, generalized pre-form queries are updated with the point of care input 150 to craft multidimensional quires 170 to query the database 130 and generate an initial list or showing of relevant data 180. As more point of care input 150 is entered, the multidimensional query 170 can be further refined for relevance by the input preprocessor 160. Other aspects can also be included to further refine the multidimensional queries 170 and the retrieval of relevant data 180. For example, this can include analyzing “click” scoring data associated with the stores fields on the database 130. Such scoring data can indicate how long or how often other individuals may have reviewed a given record thus providing a further indication of a document's relevance or importance.

The system 100 can be employed to determine various aspects of point of care relevance. This can include creating a context sensitive “snapshot” (e.g., radiology, surgery, pathology, lab, and so forth) that uses natural language processing (NLP) to determine most relevance information from EMR and prior reports. This includes employing preprocessing algorithms that characterize the certainty of the findings (e.g., positive, negative, uncertain) to populate the snapshot in the patient domain. This can also include providing images and lists of the most similar exams based upon clinical history and text for a report

Relevant data can be correlated across medical domains such as searching for relevant data related to radiology, pathology, and surgery, for example. This includes providing automated feedback to an interpreting physician when correlated documents are received using NLP, for example. Preprocessing algorithms can determine likelihood that subsequent documents have a high likelihood of correlating with a previous document. This includes tracking and discovering discrete fields from medical records transactions (e.g., HL7) to populate a database and convert to more easily processed forms. This can include segregating fields based on Date, time to Year, Month, Day of month, Day of week, and time of day, for example. The NLP document preprocessing can also define positive, neutral, or negative statements extracted from the record. Additionally, NLP preprocessing can be employed to define major portions of documents, such as can include subjective, assessment, plan, impression, and so forth. Semantic preprocessing can also be applied to medical text obtained from the EMR or enter at the point of care, for example.

Regarding the associated search, search criteria can be determined that rates the most relevant medical documents the highest. This includes multi-stage search criteria that can search “on-the-fly” to define semantic relations between documents. Predefined searches can be added to the point of care input 150 to provide a hierarchical connection between medical terms. For example, lower extremity includes thigh, calf, ankle, foot and so forth where relevancy on a multi-stage search which can include semantic “closeness” between medical terms (e.g., search for related terms within X amount of words of given word, X being an integer).

Other aspects can include situational definitions and searches. For instance, a radiologist reading a CAT scan for a lymphoma patient can define one context. In another context where the search can be refined for relevance, a vascular surgeon may be seeing a patient for a first time and can automatically receive the radiologist data if deemed relevant (e.g., if scoring for a piece of data was determined above a predetermined threshold). In yet another context, a physician assistant may be treating a patient for knee with use of a predefined care path. Thus, the search can be based on a care path decision point and can be dynamically modified as additional information becomes available.

In another aspect, preprocessing extracted text can include generating a pre-search document that specifies text data and field level context data relevant to a patient encounter. The extracted text can be derived from at least one of clinical encounter data and provider input data related to the patient encounter. This includes constructing a multidimensional query from the extracted text and sending the multidimensional query to a search engine to retrieve relevant data related to the patient encounter. Over the course of the patient encounter, the multidimensional query can be revised. This includes revising the multidimensional query the patient encounter based upon an update to the clinical encounter data or the provider input data and sending the revised multidimensional query to the search engine to retrieve updated relevant data related to the patient encounter. As used herein, revising includes revising a previous query with updated query information or creating a new query that represents differences from the previous query.

As noted previously, click scoring can be added as a field to preprocessed records to identify the importance of information. This can include using log files (e.g., HIPPA) to generate relevance search criteria according to prior use and document viewing, for example. This also can include creating directed graph structures between documents from the logs that encode historical use. The scoring can calculate dwell times that indicate how important that document was to the user. Thus search criteria can be modified by a relevance scoring algorithm that can be based on directed graph structures and dwell time, for example.

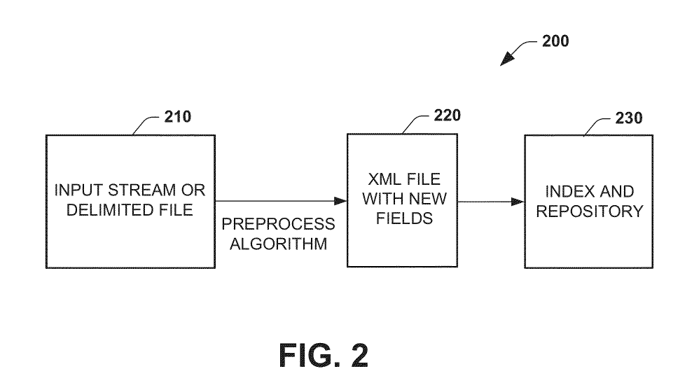

FIG. 2 illustrates a system 200 for preprocessing existing medical records in to discrete fields that can be later searched for medical relevance. The system 200 receives an input stream 210 (e.g., a Health Level 7 (HL7)) or a delimited file. The input stream is preprocessed via a preprocess algorithm and converted to an XML file 220 (e.g., SOLR file) having additional fields to further define relevance. The XML file 220 is stored in an index and repository 230 (e.g., SOLR index) which is similar to the non-SQL database 130 described above with respect to FIG. 1. The XML report received from text analysis or an HL7 transmission are but one example of preprocessing output. Preprocessing can also include multiple processing methods. This can include weighting of information (e.g., identification of importance, relevancy, accuracy, and so forth), analysis, integration, and presentation of the XML data.

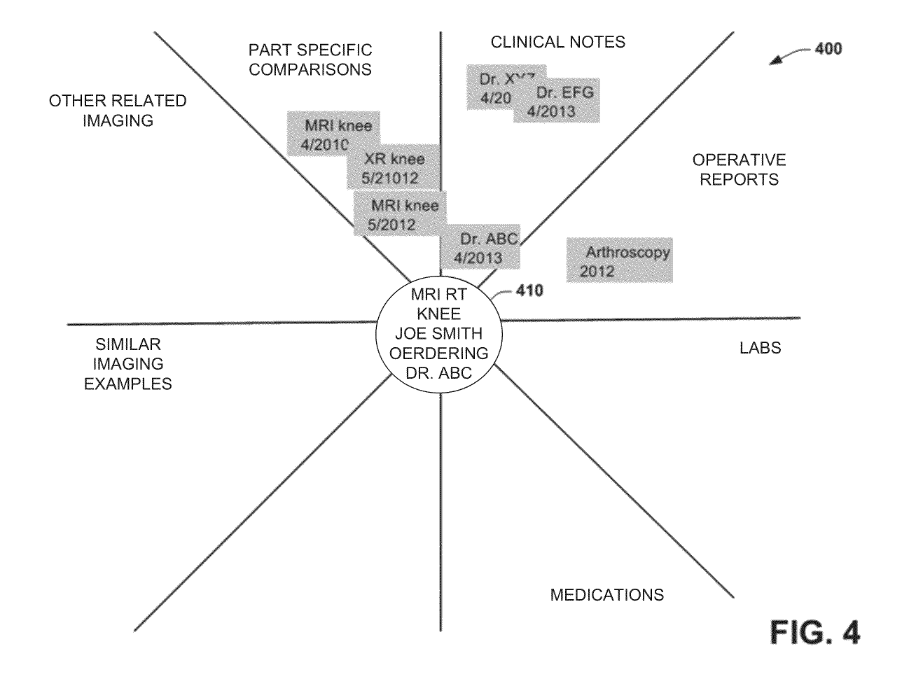

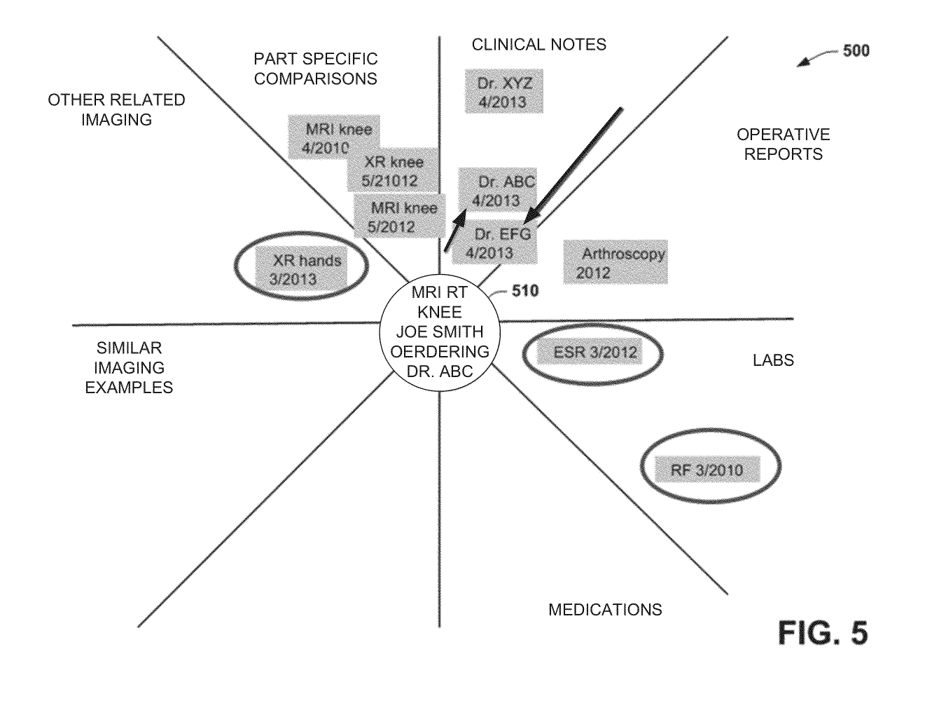

In one example, file 220 can be preprocessed as extracted text to generate a pre-search document that specifies context field data relevant to a patient encounter. Each field in the file to 200 can contribute to the understanding of context during the patient encounter. The extracted text can be derived from at least one of clinical encounter data and provider input data related to the patient encounter. After preprocessing, a multidimensional query can be constructed based on the pre-search document. The multidimensional query can then be sent to a search engine to retrieve relevant data related to the patient encounter. Results from the search engine can be provided to an output interface (See for e.g., FIGS. 4 and 5) for the patient encounter where the relevant data can be presented to the user.

The following depicts an example input stream:

```
XXXX|XXX-01-01 00:07:00.0|XXX-01-01
|XXXX|XX:17:00.0|14||XXX-XXX-SYNGO-RADIOLOGY-
      CCF|XXX|XXX|CCF|I|XXXX|LMBR
|XXXX|A|MRA CIRCLE OF WILLIS|MR||||||* * *Final Report* * *
      DATE OF EXAM: XXXXX 12:07AM  LMM  0432 - MRA
CIRCLE OF WILLIS /ACCESSION # XXXXX PROCEDURE
REASON: cva
* * * * Physician Interpretation * * * * RESULT: MRA OF THE NECK
WITHOUT CONTRAST
HISTORY: Subarachnoidxxxx TECHNIQUE: Time of flight MRA of the
      cervical circulation was performed. COMPARISON: none
      FINDINGS: Examination is xxxxxxxx.
IMPRESSION: Small
xxxxxxxx. Transcriptionist: PSC Transcribe Date/Time: Jan 1 XXXX
      10:14P Dictated by :
XXXXXX, MD This examination was interpreted and the report reviewed
  and electronically signed by: XXXXX, MD On Jan 1 10:14PM|
```

The preprocessor algorithm can include Identifying individual data elements. By delimited characters and location this includes generating basic XML fields defined by location, NLP of information with basic fields, identifying field types, and splitting specific field types e.g., date/time to year, month, day, and so forth, for example. This can also include adding new NLP processed fields. The new fields can include result from extracting sentences and headings, removing document specific stop words, and creating new fields e.g., positive, negative, and uncertain based on the store data. Such preprocessing can also include extracting semantic concepts like anatomy which can employ NLP processing to identify anatomy terms. As an example, this can include constructing anatomy fields using Radlex hierarchy. The following illustrates an example preprocessed XML file:

```
<add>
      <doc>
      <field name=″department″>Radiology</field>
      <field name=″category″>report</field>
      <field name=″pid″>EXXXXXX</field>
      <field name=″sex″>Male</field>
      <field name=″id″>XXXXX</field>
      <field name=″did″>XXXXX</field>
      <field name=″modality″>CT</field>
      <field name=″title″>CT PELVIS W CONTRAST</field>
      <field name=″date″>XXX-01-09T09:34:00Z</field>
      <field name=″year″>XXX</field>
      <field name=″month″>01</field>
      <field name=″day″>09</field>
      <field name=″hour″>09</field>
      <field name=″history″>office visit History of stomach cancer
      with previous gastrectomy </field>
        <field name=″site″>WRC</field>
      <field name=″physician″>XXXXX</field>
      <field name=″body″>  On the lung XXXXXXXXXX on the
      base of the bladder.
      <field name=″impression″> 1. XXXX. 2. XXXXXXX.
      3. XXXXXXXX
      </field>
      <field name=“positive″>lung bladder</field>
      <field name=“negative″>XXXX</field>
      <field name=“neutral″>XXXX</field>
      <field name=“anatomy”>pelvis trunk</field>
      <field name=“side”>none</field>
      </doc>
      </add>
```

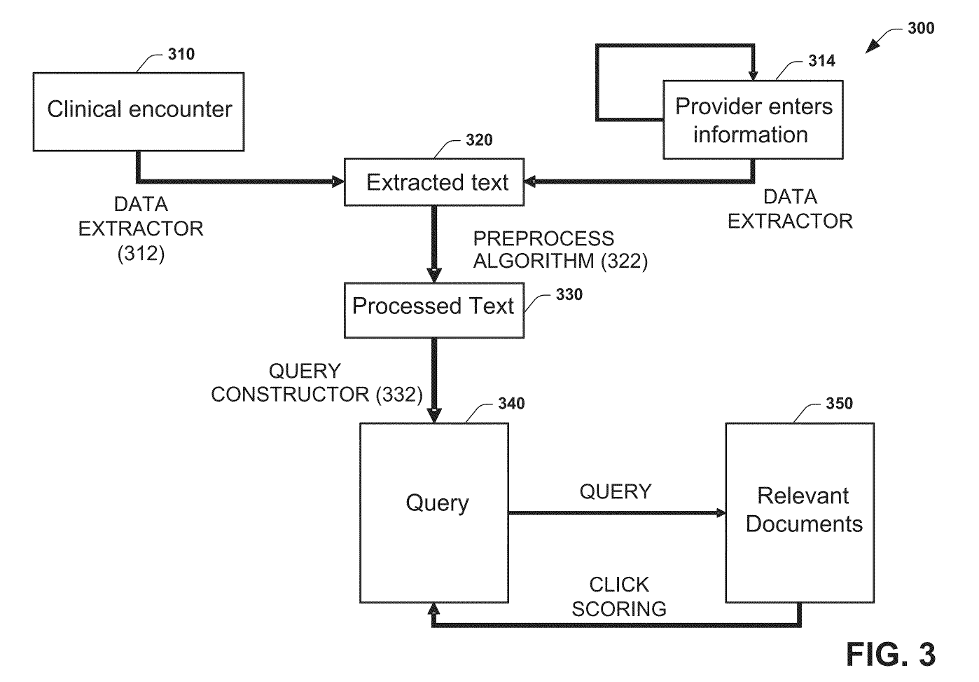

FIG. 3 is a search workflow diagram 300 illustrating an example search retrieval of relevant medical documents and data, such as in connection with a given patient encounter. As used herein a given patient encounter corresponds to a time period for a given visit or series of visits by a respective patient, such as can include any number of different phases. A patient encounter can begin, for example, when a visit or appointment is scheduled for a respective patient and can end after one or more visits related to one or more clinical conditions for the patient. In some examples, an encounter can span a single visit with a health care provider (or providers). In other examples, a series of related visits can collectively define a given encounter.

After the electronic medical data has been stored in the database, such as disclosed with respect to FIG. 2, relevance searches can then be conducted utilizing the search flow depicted in FIG. 3. Data from a clinical encounter 310 and/or when a medical provider enters patient information at 314 can be extracted via a data extractor 312 shown on the flow diagram which is described below. The data extraction can operate in real time or as a batch process depending on how the data is provided. For instance, data entered by a provider (e.g., at a point of care) can be extracted in real time dynamically as it is entered via a user input (e.g., as dictation voice data that is converted to text or as text entered via a keyboard).

As shown, patient relevant data at 314 can be updated, which update continues to refine the extracted text with corresponding update information. Such updates in input date thus results in continuing refinement in subsequent searches. For example, data can be extracted as extracted text 320 which then supplies the text to a preprocess algorithm shown on the flow diagram 300. Output from the preprocess algorithm is generated as processed text 330. The processed text can be sent to a query constructor that is programmed to generate a query at 340. The query 340 is utilized to query relevant documents (or data) 350. As a further example, click scoring can also be added to the retrieved documents to further enhance relevance.

The data extractor 312 can capture encounter Information. This can include patient MRN, other field data, and text. Extraction can include exposed text and fields in windows, for example. This can include REST-based queries and database queries (e.g., query HL7 data). An example of extracted text could be as follows:

```
      -XXXXX - XXXXXXXRight SHOULDER MRI:
TECHNIQUE:
Routine shoulder MRI was obtained.
Comparison: None.
HISTORY:
Shoulder pain and limited range of motion. Rule out calcific tendinitis.
RESULT:
ROTATOR CUFF TENDONS:
There is a focal area of low signal intensity on all pulse sequences
involving the supraspinatus tendon most consistent with calcific tendinitis.
There is thickening and intermediate signal intensity involving both
the supraspinatus and infraspinatus tendons consistent with
associated tendinosis. No evidence for a discrete tendon tear.
BICEPS TENDON:
The tendon of the long head of the biceps is intact and appropriately
located.
MUSCLES:
There is normal muscle bulk and signal intensity about the shoulder.
LABRUM:
The glenoid labrum demonstrates normal morphology and signal intensity.
ARTICULAR CARTILAGE OF THE GLENOHUMERAL JOINT:
No chondral defects identified.
ACROMIOCLAVICULAR JOINT:
Mild arthrosis is present involving the acromioclavicular joint.
BONE MARROW:
Bone marrow signal intensity is otherwise within normal limits.
JOINT FLUID AND SYNOVIUM:
  There is a normal amount of fluid within the glenohumeral joint. Slight
      increase fluid is
present within the subacromial-subdeltoid bursa and subscapularis recess.
SURROUNDING SOFT TISSUE:
The surrounding soft tissues otherwise demonstrate normal signal
intensity.
IMPRESSION:
  Calcific tendinitis involving supraspinatus tendon. Mild tendinosis
involving supraspinatus and infraspinatus tendons. Slight increase
fluid in the subacromial subdeltoid bursa.
```

The preprocess algorithm 322 can identify specific data fields such as Patient ID, Encounter type, Anatomy, Exam, and so forth. This includes identifying text headings, identify sentences, removing document specific stop words, applying NLP processing to sentences and headings, and creating new fields having word order. An example of preprocessed text can be generated as follows:

```
      Report array:
tendinosis|calcific tendinitis|subacromial subdeltoid
bursa|supraspinatus|ACROMIOCLAVICULAR JOINT|
subacromial subdeltoid|infraspinatus tendons|supraspinatus tendon|BICEPS
TENDON|ACROMIOCLAVICULAR|
subdeltoid bursa|tendinitis|increase fluid|infraspinatus|calcific|SHOULDER
MRI|subacromial|TENDONS|subdeltoid|
ROTATOR CUFF TENDONS|subscapularis recess|MRI|increase|pulse
sequences|Shoulder pain|subscapularis|limited range|CUFF
      TENDONS|ROTATOR
CUFF|focal area|bursa|thickening|low signal|sequences|arthrosis|
ROTATOR|HISTORY|limited|SHOULDER|recess|motion|range|focal|
      pulse|Rule|area
|pain|CUFF|low|appropriately|BICEPS|muscle
bulk|morphology|long head|tendon tear|muscle|discrete tendon tear|
ARTICULAR CARTILAGE|chondral defects|bulk|long|head|discrete
tendon|tear|CARTILAGE|ARTICULAR|discrete|chondral|
GLENOHUMERAL JOINT|LABRUM|defects|tendon|
      GLENOHUMERAL|BONE MARROW| Bone marrow
signal|glenoid labrum|marrow signal|soft tissues|MARROW|JOINT
FLUID|SOFT TISSUE|SYNOVIUM|SOFT|BONE|signal|glenoid|
      MUSCLES|tissues|TISSUE|JOINT|FD
Impression array:
tendinosis|subacromial subdeltoid bursa|supraspinatus|subacromial
subdeltoid|infraspinatus tendons| supraspinatus tendon|Calcific
      tendinitis|subdeltoid
bursa|increase fluid|infraspinatus|subacromial|tendinitis|
subdeltoid|Calcific|increase|tendons|tendon|bursa|fluid
```

The query constructor 332 can apply preprocessed text and fields to query templates. This can include construct queries, modifying queries based on user preferences, and modifying queries based on user context, for example. An example query can be generated by the constructor 332 as follows:

```
      Positive:
%22 SHOULDER MRI %22~5 +
%22 HISTORY Shoulder pain limited range motion Rule calcific
      tendinitis %22~5 +
%22 ROTATOR CUFF TENDONS focal area low signal supraspinatus
      calcific tendinitis
%22~5 +
%22 thickening signal supraspinatus infraspinatus tendons
tendinosis %22~5 +
%22 ACROMIOCLAVICULAR JOINT arthrosis acromioclavicular
joint %22~5 +
%22 increase fluid subacromial-subdeltoid bursa subscapularis recess
%22~5 +
%22 Calcific tendinitis supraspinatus tendon %22~5 +
%22 tendinosis supraspinatus infraspinatus tendons %22~5 +
%22 increase fluid subacromial-subdeltoid bursa %22~5
Maybe:
Negative:
-(%22 discrete tendon tear %22~5 +
%22 BICEPS TENDON tendon long head biceps appropriately %22~5 +
%22 MUSCLES muscle bulk signal shoulder %22~5 +
%22 LABRUM glenoid labrum morphology signal %22~5 +
%22 ARTICULAR CARTILAGE GLENOHUMERAL JOINT chondral
      defects %22~5 +
%22 BONE MARROW Bone marrow signal %22~5 +
%22 JOINT FLUID SYNOVIUM fluid glenohumeral joint %22~5 +
%22 SOFT TISSUE soft tissues signal %22~5 + )
```

FIGS. 4 and 5 illustrate example graphical user interfaces that can be utilized to display relevant medical data that has been retrieved according to the systems and methods described herein. In these examples, multi-axis output displays include a relevance display region e.g., a central orb). Retrieved data of higher relevance can be located closer to the relevance display region and retrieved data of lower relevance can be located farther from the relevance display region, for example.

Referring to FIG. 4, an interface 400 depicts an initial search based upon preliminary information such as a patients name, the attending doctor, and the area of concern which is the right knee in this example. This information is provided at the center of the interface 400 as an orb 410 (e.g., relevance display region) and represents the information known at a given current time (e.g., clinical encounter information or entered patient information from FIG. 2). Axis lines emanating from the orb 410 represent the extra dimensions that are brought in automatically with the preliminary search data represented in the orb. For example, such axis can include part specific comparisons, other related imaging, similar imaging examples, medications, labs, operative reports, clinical notes, and so forth. As shown, several knee reports are initially retrieved as relevant along with a few clinical notes, and a single operative reports. The closer to the orb (e.g., relevance display region) that the data item appears, the higher the computed relevance.

As the physician continues to enter diagnostic evaluation or other patient-related information data (e.g., as dictation data), other documents or other data objects may then be determined as relevant, others may move further from the orb 410, and some may disappear altogether from the interface 400 as additional relevance is determined. Movement of the data relative to the orb 410 thus can vary depending on the computed relevance of the object based on applying the constructed query to the pre-processed data. In another example of how data could be presented on the interface 400 (e.g., rather than proximity to a central orb) could include a thermal plot, for example, where temperature (or other type) gradients indicate relevancy (e.g., lighter colors less relevance darker colors more relevant).

For example, if the attending physician dictated rheumatoid arthritis, then the interface 400 may then be updated via a new search such as shown in the interface 500 of FIG. 5 and based on the additional input from the attendant health professional. As shown in FIG. 5, an orb 510 now has various records retrieved, removed, and/or positioned differently than the interface 400 based on the new point of care input data. For example, lab data is now pulled near the orb 510 from the search dimension Labs. In another example, a report from Doctor ABC is moved away from the orb 510 as being deemed less relevant while a report from Doctor DEF is moved closer to the orb 510 as being determined more relevant. Similarly, a report relating to the hands in an “Other medical imaging” axis may be retrieved as arthritis in the knee could also be related to arthritis in the hand. By continually refining search in this manner along multiple dimensions, extraneous information can be filtered out and more relevant information provided more prominently to the attending professional. As more point of care input is entered, additional searches can be conducted and the interface can continue to be updated to reflect updated relevance and associated information.

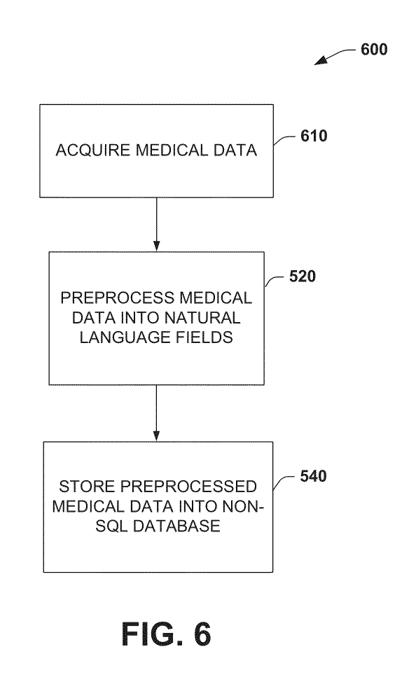

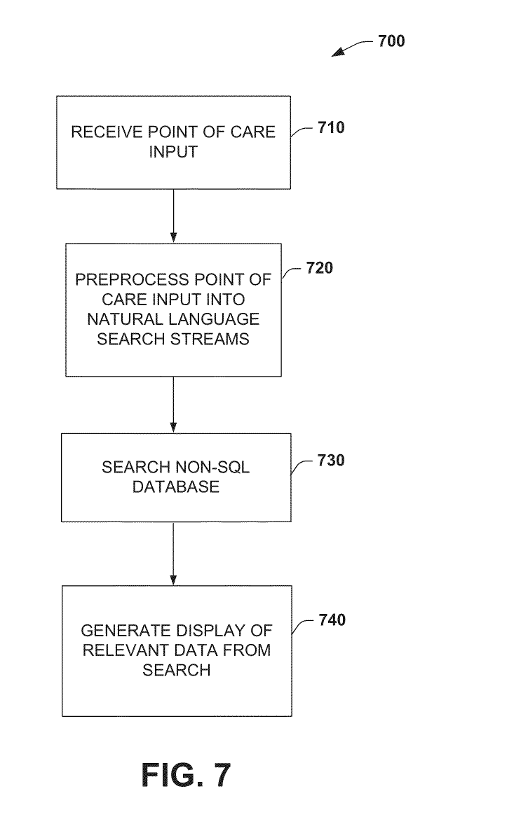

In view of the foregoing structural and functional features described above, an example method will be better appreciated with reference to FIGS. 6 and 7. While, for purposes of simplicity of explanation, the methods are shown and described as executing serially, it is to be understood and appreciated that the methods are not limited by the illustrated order, as parts of the methods could occur in different orders and/or concurrently from that shown and described herein. Such methods can be executed by processor, such as in a server or other computer, for example.

FIG. 6 illustrates an example method 600 for preprocessing medical records into a non-SQL database. At 610, medical data is acquired. Such medical data can be acquired from electronic medical records, images, journals, web-based sources, and so forth. At 620, the medical records are preprocessed into natural language fields that can be employed for subsequent searches. Such fields can be stored as XML files for example. At 630, the preprocessed medical data records are stored in a non-SQL database (e.g., SOLR APACHE database). After the data has been stored at 630, the method depicted in FIG. 7 can be applied to retrieve relevant information from the database across multiple dimensions.

FIG. 7 illustrates a method 700 for preprocessing point of care input to generate a query to retrieve relevant medical data from a non-SQL database. At 710, point of care input is received. For example, this could be from dictation data generated by a point of care medical professional. At 720, the input data is preprocessed into natural language search streams such as generated by the flow process depicted in FIG. 3. At 730, the search streams are submitted to a search engine (e.g., natural language search engine) which queries the non-SQL database which was populated by the method depicted in FIG. 6. At 740, the method 700 generates a display of relevant information based upon the point of entry input and other preformed query data that can include positive, negative, uncertainty restrictions, related patient information, related lab information, other imaging information, related patient information, similar imaging examples, clinical notes, part specific comparisons, operative reports, and medications, for example. Additional relevance information can be included such as click scoring data which indicates how long or how often other users examined a particular document or image, for example.

In view of the foregoing structural and functional description, those skilled in the art will appreciate that portions of the invention may be embodied as a method, data processing system, or computer program product. Accordingly, these portions of the present invention may take the form of an entirely hardware embodiment, an entirely software embodiment, or an embodiment combining software and hardware, such as shown and described with respect to the computer system of FIG. 25. Furthermore, portions of the invention may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments of the invention have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory (e.g., a non-transitory computer readable medium) that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A method comprising, comprising:
preprocessing extracted text, by a processor, to generate a pre-search document that specifies context field data relevant to a patient encounter, the extracted text being derived from at least one of clinical encounter data and provider input data related to the patient encounter;
constructing a multidimensional query, by the processor, based on the pre-search document;
sending the multidimensional query, by the processor, to a search engine to retrieve relevant data related to the patient encounter; and
generating an output, by the processor, for the patient encounter based on the retrieved relevant data.

2. The method of claim 1, further comprising repeating the preprocessing and the constructing for revising the multidimensional query based upon the clinical encounter data or the provide input data being updated.

3. The method of claim 2, wherein the multidimensional query is revised based on positive statements, negative statements, or uncertain statements derived from the provider input data.

4. The method of claim 1, further comprising generating a multi-axis output display to view different dimensions of relevant data retrieved from the search engine.

5. The method of claim 4, wherein generating the multi-axis output display includes generating a relevance display region on the multi-axis output display, wherein retrieved data of higher relevance is located closer to the relevance display region and retrieved data of lower relevance is located farther from the relevance display region.

6. The method of claim 5, wherein generating the relevance display region includes generating display axis regions from the relevance display region that represent contextual dimensions that are retrieved with preliminary search data associated with the relevance display region.

7. The method of claim 6, wherein the display axis regions include part specific comparisons, other related imaging, similar imaging examples, medications, labs, operative reports, and clinical notes.

8. The method of claim 1, further comprising ranking of the relevant data based on a click scoring criteria.

9. The method of claim 1, further comprising preprocessing electronic medical records into discrete natural language fields.

10. The method of claim 9, further comprising searching the discrete natural language fields via the multidimensional query to determine the relevant data.

11. One or more non-transitory computer readable media having instructions executable by a processor, the instructions comprising:
a preprocessor to process extracted text to generate a pre-search document that specifies context field data relevant to a patient encounter, the extracted text being derived from at least one of clinical encounter data and provider input data related to the patient encounter;
a query constructor to generate a multidimensional query from the extracted text;
a query sender to submit the multidimensional query to a search engine to retrieve relevant data related to the patient encounter; and
an interface to provide an output for the relevant data for the patient encounter based on the retrieved relevant data.

12. The media of claim 11, further comprising a graphical user interface to display the relevant data.

13. The media of claim 12, wherein the graphical user interface includes a relevance node that defines initial data and a plurality of axis that define multiple dimensions related to the initial data.

14. The media of claim 13, wherein the plurality of axis include at least one of clinical notes, operative reports, labs, medications, similar imaging examples, other related imaging, and part specific comparisons.

15. The media of claim 14, further comprising a preprocessor to preprocess the extracted text into to discrete fields, the discrete fields including values representing positive statements, negative statements, or uncertain statements derived from the clinical encounter data.

16. A computer-implemented method, comprising:
preprocessing extracted text, by a processor, to generate a pre-search document that specifies context field data relevant to a patient encounter, the extracted text being derived from at least one of clinical encounter data and provider input data related to the patient encounter;
constructing a multidimensional query, by the processor, from the extracted text;
sending the multidimensional query, by the processor, to a search engine to retrieve relevant data related to the patient encounter;
revising the multidimensional query, by the processor, during the patient encounter based upon an update to the clinical encounter data or the provider input data; and
sending the revised multidimensional query, by the processor, to the search engine to retrieve updated relevant data related to the patient encounter.

17. The method of claim 16, further comprising scoring data retrieved by the multi-dimensional query to rank the relevance of the relevant data.

18. The method of claim 17, wherein the scoring data further comprises indicating at least one of how long or how often other individuals have reviewed a given record to provide a further indication of the relevance of the relevant data.

19. The method of claim 18, further comprising correlating relevant data across medical domains to automatically search for other relevant data.

20. The method of claim 16, further comprising generating an output display having a relevance display region, wherein relevant data having higher relevance is located closed to the relevance display region and relevance data having lower relevance is located farther from the relevance display region.
